(19) United States
(12) Patent Application Publication
(10) Pub. No.: US 2015/0161389 A1
(43) Pub. Date: Jun. 11, 2015

(54) SYSTEM AND METHOD FOR THE DETECTION AND PREVENTION OF BATTERY EXHAUSTION ATTACKS

(71) Applicant: PRISM TECHNOLOGIES LLC, Omaha, NE (US)

(72) Inventor: Richard L. Gregg, Omaha, NE (US)

(73) Assignee: PRISM TECHNOLOGIES LLC

(21) Appl. No.: 14/567,058

(22) Filed: Dec. 11, 2014

Related U.S. Application Data
(60) Provisional application No. 61/914,702, filed on Dec. 11, 2013.

(51) Int. Cl. G06F 21/55

(52) U.S. Cl. CPC G06F 21/554; G06F 2221/034

(57) ABSTRACT

A system and method for detection and prevention of battery exhaustion attacks for use with a wireless sensor network and in mobile devices is provided. The system and method provides capability to a wireless sensor network to meet its battery lifespan requirements by guaranteeing a specific percentage of the overall battery life of each sensor node through the detection and prevention of battery exhaustion attacks.

The present application claims the benefit of Provisional Application No. 61/914,702, filed Dec. 11, 2013, the contents of which are incorporated by reference.

### BACKGROUND OF THE INVENTION

1. Field of the Invention

The present invention generally relates to the detection and prevention of battery exhaustion attacks in mobile devices. More particularly, the present invention relates to a batter exhaustion detection and prevention system for use with a wireless sensor network.

2. Description of the Prior Art

A wireless sensor network (WSN) is composed of a large number resource constrained sensor nodes that operate in an unattended hostile environment. These characteristics make the sensor network vulnerable to attacks both inside the sensor network by malicious nodes or outside the sensor network by a determined adversary. One kind of attack on battery powered devices is known as the sleep deprivation torture or battery exhaustion attack. In this attack, a malicious user or node may interact with a node in an otherwise legitimate way, but for no other purpose than to consume the battery powered nodes energy. There are three primary methods for an attacker to drain the battery of a portable device: 1) service request power attacks, 2) benign power attacks, and 3) malignant power attacks. The research in this area has focused primarily on detection of power attacks on handheld devices such as cell phones, laptops, and personal digital assistants. While there has been quite a bit of research around the detection of power attacks, there has not been much work applied to the prevention of such attacks once they are detected. Therefore, there is a need to provide capability to a wireless sensor network to meet its battery lifespan requirements by guaranteeing a specific percentage n the overall battery life of each sensor node through the detection and prevention of battery exhaustion attacks.

### SUMMARY OF THE INVENTION

The present invention in a preferred embodiment contemplates a system and method for detecting and preventing battery exhaustion attacks including collecting data from a battery powered mobile device; analyzing the collected data; determining if a power attack has occurred by analyzing the data using a continuous-time Markov chain algorithm; and preventing the power attack if the power attack occurred.

It is understood that both the foregoing general description and the following detailed description are exemplary and exemplary only, and are not restrictive of the invention as claimed.

### DESCRIPTION OF THEE DRAWINGS

The accompanying drawings, which are incorporated in and constitute a part of the specification, illustrate preferred embodiments of the invention. Together with the description, they serve to explain the objects, advantages and principles of the invention. In the drawings:

FIG. 1 is a block diagram of a sensor network embodying the present invention;

FIG. 2 is a block diagram of a sensor node embodying the present invention;

FIG. 3 is a detailed schematic of a general purpose wireless sensor node embodying the present invention;

FIG. 4 is a flow chart of the sequence of acts that occur when detecting and preventing a battery exhaustion attack of the preferred embodiment;

FIG. 5 is a flow chart oldie sequence of acts that occur when collecting data for use by the preferred embodiment;

FIG. 6 is a flow chart of the sequence of acts that occur when analyzing data for use by the preferred embodiment; and

FIG. 7 is a flow chart of the sequence of acts that occur when detecting a battery exhaustion attack of the preferred embodiment.

### DETAILED DESCRIPTION

The present invention is directed to a system and method for the detection and prevention of battery exhaustion attacks in mobile devices. As discussed below, the system and method of the present invention provide the capability of meeting the battery lifespan requirements of mobile devices by guaranteeing a specific percentage of the overall battery life thereof.

As discussed below, the present invention embodies a host-centric approach and does not employ a system administrator. Instead, detection and prevention are localized under the control of the sensor node 1 itself. As such, the sensor node 1 employs hardware to measure temperature, voltage, and current to provide a lightweight version of existing smart battery technology. A host centric approach is more universally adaptable to any type of sensor network topology and provides a “least common denominator” approach (i.e. doesn't require clustering, etc.).

The host-centric approach of the present invention takes the non-ideal properties of batteries into account to guarantee a specific percentage of the overall battery life of the system.

To facilitate detection, the system and method of the present invention can use a battery discharge curve calculation model, a multiple linear regression model, a node activity model, and for a simple dynamic threshold calculation model. The battery discharge curve calculation model could be used to account for the non-ideal properties of the battery to calculate a discharge curve over time (current, voltage, temperature, etc.), The multiple linear regression model could be used to compare estimated power with power consumed (CPU load, transceiver duty cycle, network bytes written per second, network bytes read per second, Media Access Control (MAC) idle time, sensor node sleep time, etc.). The node activity model could be used to monitor the frequency of node activity (call chain activity, distribution of lower management states, duty cycle of sensor node sleep time versus awake time, etc.) to detect abnormal use. The simple dynamic threshold calculation model based on the instantaneous current of a sensor node could be used this approach could use the lightweight smart battery technology as proposed above combined with the expected versus actual time a node spends in various power management states as a detection mechanism.

To facilitate prevention, the system and method of the present invention can use Media Access Control (MAC) layer authentication, code attestation, a delayed response model, external notifications, and/or a continuous-time Markov Chain. MAC layer authentication could provide a good first line of defense against all power attacks. Delaying or ignoring code execution, increasing sleep time at the MAC layer, or extended periods of flat out hibernation until an attack is no longer detected could also be used—this approach could be used to prevent service request and benign power attacks. Sending alarms to control topology or to the local neighborhood to control routing until an attack is no longer detected could also be used in order to reduce collateral damage on unaffected portions of the network. A continuous-time Markov chain is a probability model characterized by the Markovian property that, given the present state, the future is independent of the past.

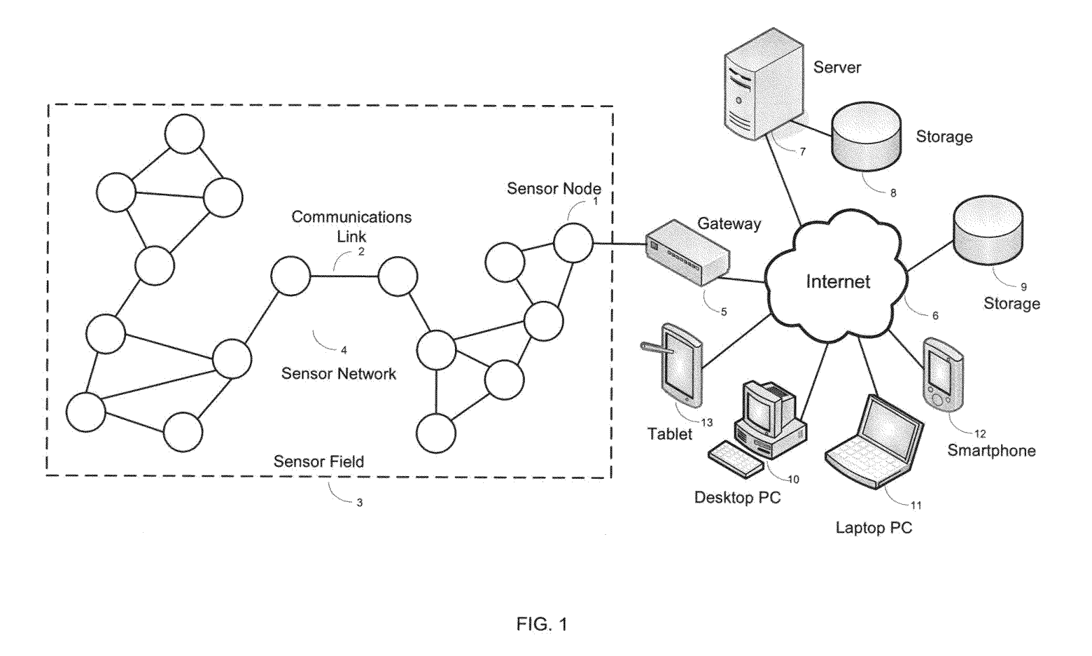

FIG. 1 depicts a sensor field 3 including a sensor network 4 with several sensor nodes 1 and communications links 2. The sensor nodes 1 and communications links 2 can be either wired wireless, or a combination of wired and wireless communication to communicate with each other and the gateway 5.

It is common for a sensor network to use proprietary protocols to communicate within the sensor network. The gateway 5 provides protocol translation and routing between the sensor network and the Internet 6 which utilizes the Internet Protocol suite (IP TCP/IP, UDP/IP, HTTP, etc.), A server 7 and associated storage 8 provides application software and database management to operate and monitor the sensor network 4. Alternately, data from the sensor network 4 can be stored in remote storage 9 which can be accessed from the Internet 6. The application software resident and executing on the server 7 and the data resident of the server 7 and alternatively the remote storage 9 can be accessed by a variety of client computer devices including but not limited to desktop personal computers 10, laptop personal computers 11, smart phones such as an Apple iPhone 12, and tablet computers 13 such as an Apple iPad.

While the configuration shown in FIG. 1 has a single sensor field, a single server with associated storage, and a single remote storage, the system of the present invention is adapted to be used in other configurations which may include multiple sensor fields, multiple sensor networks, multiple servers, multiple remote storage facilities, and multiple client computer devices.

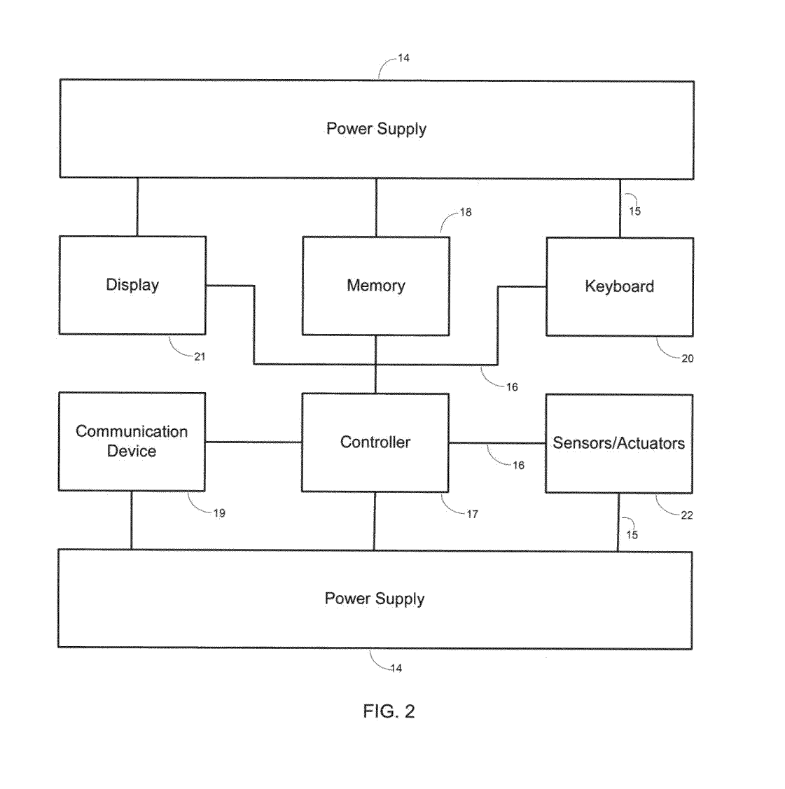

FIG. 2 further provides a block diagram of the sensor node 1, the components of which may be optional. The sensor node 1 uses a micro-controller 17 that executes a program controlling the operation of the sensor node 1. The sensor node 1 also includes a communications bus 16 that connects the micro-controller 17 to memory 18, a communication device 1 such as a wireless data radio or a wired network adapter, an optional keyboard 20, an optional display 21, and sensors 22 that monitor the environment of the sensor field 3 and/or actuators 22 that control the environment of the sensor field 3. In some cases, sensors and actuators may not be needed.

A power supply 14 of the sensor node 1 typically includes two AA cell batteries connected in series to provide 3 volts and 3,000 milliamp hours of power to the sensor node 1 through a power supply bus 15. It will be recognized by those of ordinary skill in the art that the sensor node 1 may also receive power from a power supply connected to the electrical grid. It will also be appreciated by those of ordinary skill in the art that other types of batteries can be used as well.

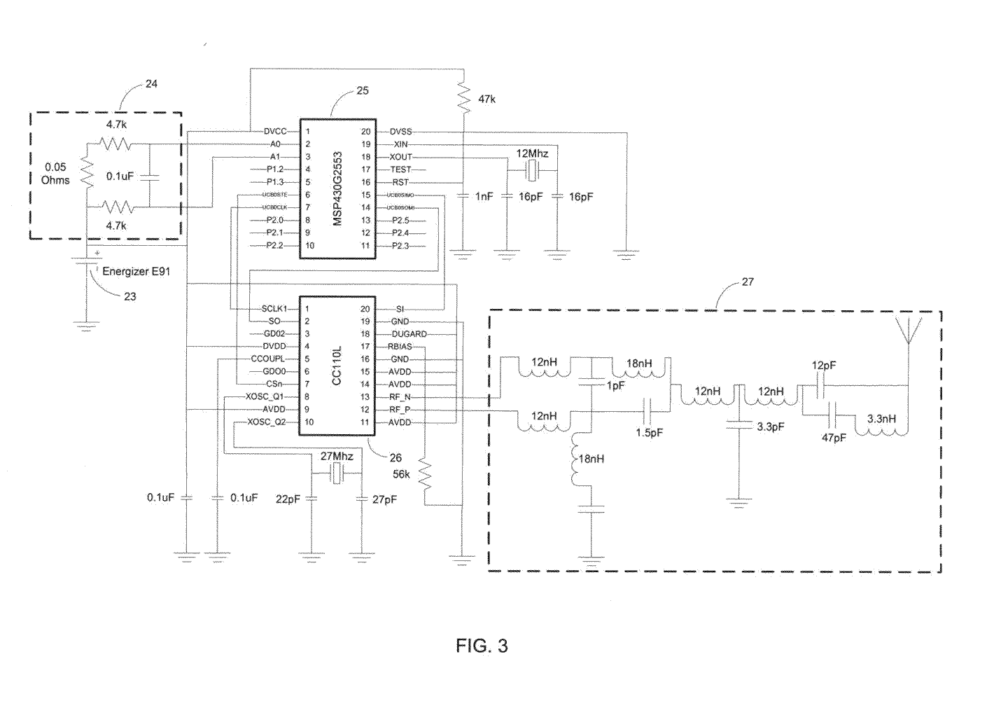

FIG. 3 further provides a detailed schematic of the sensor node 1. The sensor node 1 use a Texas Instruments MSP430G2553 mixed signal micro-controller 25 using the serial peripheral interface (SPI) bus to communicate with to a Texas instruments CC110L transceiver 26. The transceiver 26 is connected to a 915 MHz antenna 27 which provides the sensor node 1 with wireless data radio capability. The micro-controller 25 interfaces to sensors and actuators using available port pins (i.e., 4, 5, 8, 9, 10, 11, 12 and 13). Two Energizer E91 alkaline batteries 23 are used to power the sensor node 1. The power supply is connected to a passive circuit 24 which provides the current being consumed by the sensor node 1. The current is measured by the micro-controller 25 using a differential analog-to-digital converter which is built into the micro-controller 25. The micro-controller 25 also has the built-in capability to monitor power supply voltage and sensor node temperature. The micro-controller 25 typically executes software which is specific to the requirements of the sensor field 3 being monitored and/or controlled.

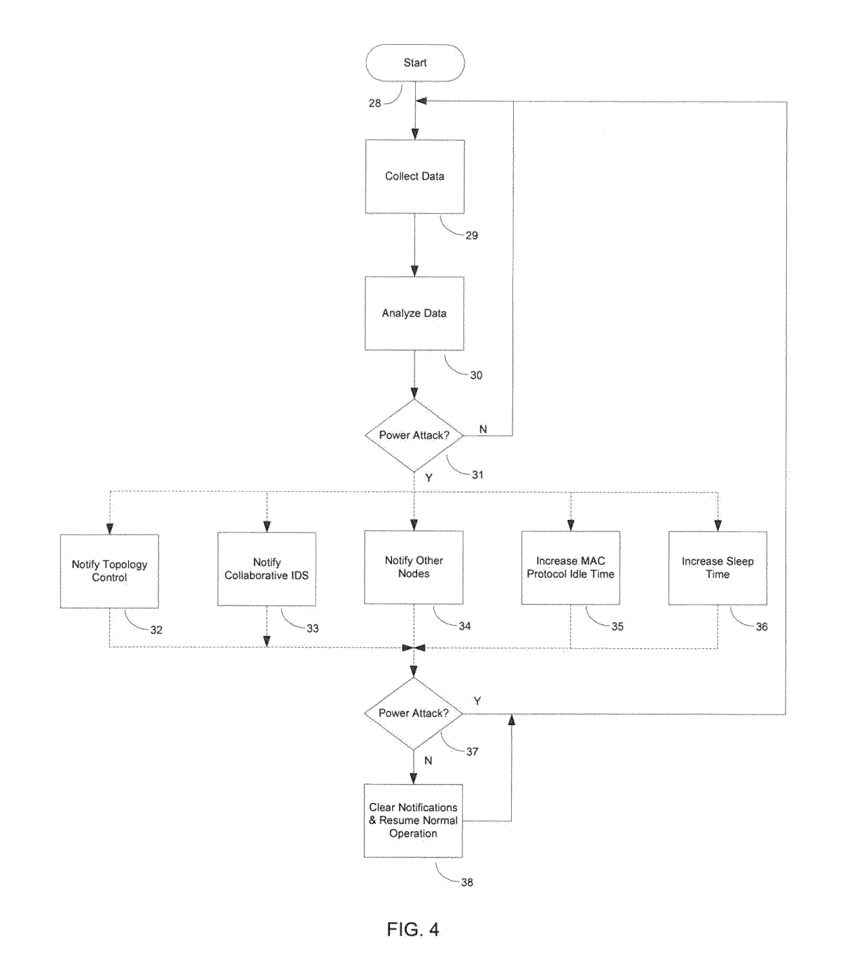

FIG. 4 provides a high level flow chart of the acts used by the sensor node to detect and prevent a battery exhaustion attack. The process starts at 28 and is continuously repeated. First, the currently available data is collected at 29 and the collected data is stored in memory for subsequent analysis at 30. Once analysis of the data is performed, the results of the analysis are forwarded to act 31 where the probability of power attack is determined using a continuous-time Markov Chain (CTMC) algorithm. If there is no power attack detected, the process starts over at act 28. If a power attack is detected at act 31, there are one or more of five actions (or prevention algorithms) that can take place to prevent the power attack depending on the resource constraints of the sensor node (memory, processor power, battery life, etc.) and the desired level of prevention.

If a power attack is detected at act 31, the sensor node 1 could notify the topology control protocol at 32 to take actions that mitigate the power attack. Topology control in a sensor network is used to provide routing within the network and add or remove nodes from the network; if a power attack is detected at act 31, a proprietary protocol could be used to notify other nodes of a power attack at 34, so that the other nodes may be able to mitigate the attack; if a power attack is detected at act 31, an increase in the media access control (MAC) layer protocol idle time at 35 used in the sensor node could be adjusted using several techniques to mitigate a power attack; if a power attack is detected at act 31, an increase in the sensor node sleep schedule at 36 could also be used to mitigate a power attack.

Also, if a power attack is detected at act 31, a collaborative Intrusion Detection System (IDS) at act 33 could be triggered by the attack and by the subsequent local agent alerts of the neighboring sensors. The process of collaborative intrusion detection ends by having the participating sensors jointly expose the source of the attack. Collaborative intrusion detection exchanges the outputs of the local agents with those sensor node local agents in the neighborhood to narrow down set of possible nodes that could be the attacker. Using IDS at act 33, the honest nodes have to jointly expose the attacker—they have to reach agreement on the attacker's identity. The cooperative intrusion detection algorithm has several phases: 1) Initialization Phase, 2) Voting Phase, 3) Publish Key Phase, 4) Exposing the Attacker, and 5) External Ring Reinforcement Stage.

Initialization Phase: Each node is preloaded with a one-way key chain. The proposed implementation uses the existing SPINS key chain algorithm. The initialization of this phase takes place right after network deployment. The duration of the phase is short enough so that the absence of the attacker is assumed. All nodes discover their immediate neighbors during this time, which is a standard procedure in all routing protocols. Each node will then announce their key chain to all neighbors.

Voting Phase: During the voting phase, each node in the neighborhood sends its vote to all the other members and respectively collects their votes. When a node receives a vote, it sets a timer. During that time it waits to receive the votes from the rest of the nodes and buffers them as it waits for key publishing (next act) in order to authenticate the votes. The vote of each node needs to reach all other neighborhood nodes. Since the votes (messages) are signed with a key known only to the sender, the attacker cannot change the votes. However, the attacker may refuse to forward votes, such that they must be forwarded through other paths, bypassing the attacker. To ensure that votes propagate to all nodes the SPINS uTESLA broadcast message authentication protocol is used.

Publish Key Phase: During key publishing phase, each node broadcasts the key of its hash chain which was used to sign the vote. If this process is successful, the vote is accepted as authentic. When the timer set by the voting phase expires the nodes move to the final act of processing and expose the attacker. In the case where a key has been missed, the vote is discarded. Since nodes are not time synchronized, and some nodes may start publishing their keys while others are still in the voting stage, consideration must be given to the “man-in-the-middle” attack. When a node sends its vote, an attacker may withhold the vote until the node publishes its key. The node can change the vote, sign it again with the new key and forward it to the next node. Following that, the attacker also forwards the key and the receiver will be able to verify the signature and accept the fake vote as authentic. This problem is dealt with by relying on residual paths amongst the nodes. As votes are forwarded by all nodes, even if an attacker refuses to forward a vote, it will arrive to the other nodes using other paths.

Exposing the Attacker: When each node has collected and authenticated the votes from all other neighborhood nodes, it will have knowledge of all the corresponding suspects, its own included. Each node will then count how many times a node appears in the suspect list in order to produce a final intrusion detection result (i.e. the attackers ID). The nodes will reach the same result and remove the attacking node from the network.

External Ring Reinforcement Stage: In the event that the voting stage is inconclusive, the nodes move to the external ring reinforcement stage where the nodes are called upon to support their honest neighbors. This causes a majority vote to take place between honest neighbors to identify the attacker thus removing the attacking node from the network.

Once action is taken to mitigate the attack, the process used to evaluate the existence of an attack is executed again at 37 based on all of the available data which is repeatedly collected and updated, since monitoring for power attacks is performed continuously. If after analysis at act 37, the power attack does not exist, the proper notifications are given at 38 to any of the five prevention algorithms: 1) notify topology control protocol at act 32, 2) notify collaborative at act 33, 3) notify other nodes at act 34, 4) increase MAC protocol idle time at act 35, and/or 5) increase the sensor node sleep time at act 36. As a result of the notification at act 38, the normal operation of the sensor node is resumed as if there was no power attack that had been detected.

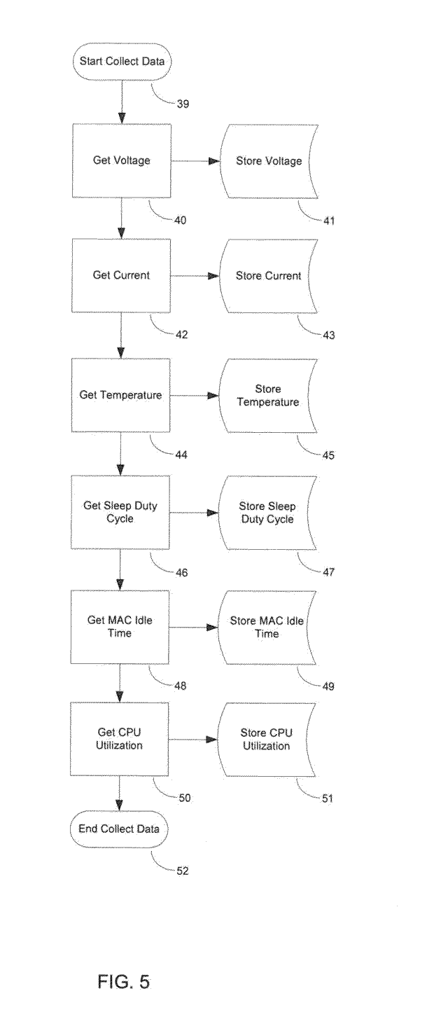

FIG. 5 details the acts taken during the collection of data from the sensor node. The process starts at 39. The voltage is read at 40 from the micro-controller and is stored into memory at 41. The current is read at 42 from the micro-controller's differential analog to-digital converter (FIG. 3) and is stored into memory at 43. The temperature of the sensor node is read at 44 from the micro-controller and is stored into memory at 45. The current sleep duty cycle is read at 46 from the application software executing in the micro-controller and is stored into memory at 47. The current MAC idle time is read at 48 from the application software executing in the micro-controller and is stored in memory at 49. The micro-controller's CPU utilization as a percent during awake times is calculated at 50 and stored in memory at 51. At this point, the collection of data has been completed at 52.

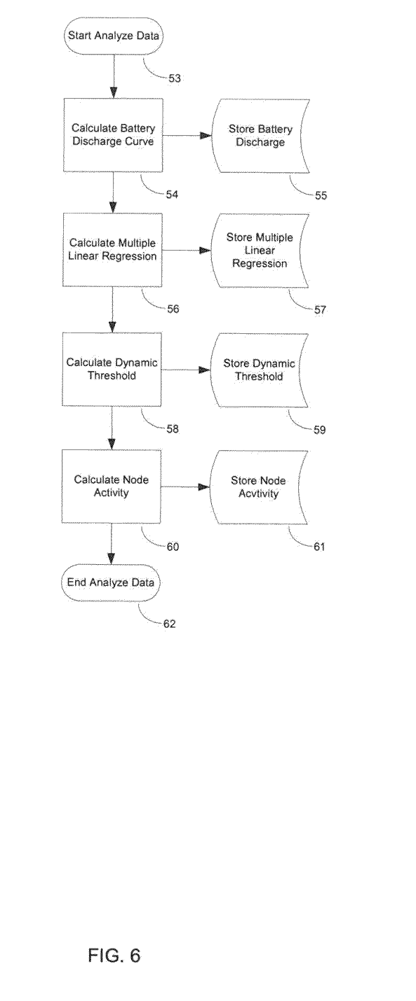

FIG. 6 details the acts taken during the analysis of the data collected in FIG. 5. The process starts at 53. The battery discharge curve is calculated at 54 and stored at 55. The battery discharge curve is based on the known characteristics of the battery supply used in the sensor node and is compared to the actual power consumption of the node itself to determine an actual discharge curve of the sensor node. The calculation used to determine the discharge curve includes current voltage stored at 44, current consumption stored at 43 and sensor node temperature stored at 45. The discharge curve is historical and is updated with each pass through the monitoring loop in FIG. 4.

The correlation between micro-controller CPU load and power consumption gives rise to the idea of predicting power consumption of the overall sensor node based on various system metrics (CPU load, transceiver duty cycle, network bytes written per second, network bytes read per second, Media Access Control (MAC) idle time, sensor node sleep time, etc.) using a linear regression model calculated at 56. The estimated power is compared with the actual power measurement to detect a battery exhaustion attack where the estimated power equals B₀, the overall baseline of power consumed plus the power consumed based by the CPU load. B₁×(% CPU Load), plus the number of network bytes written per second, B₂×(network bytes written per second), plus the number of network bytes read per second, B₃×(network bytes read per second). Other factors such as MAC idle time and sensor node sleep time could be included in the equation as well. The result of the linear regression model is stored in memory 57.

The dynamic threshold calculation (DTC) (calculated at 58) compares the instantaneous current stored at 43 consumed by a device to a dynamic threshold calculation algorithm. A malicious process being run on a device without knowledge of the user increases the instantaneous current (IC) drawn from the device's battery. Such an activity could include a worm spread, virus infection, network probing, flooding, or a denial of service attack (DoS). All of these malicious activities can cause the current to rise which could be detected. DTC is a hybrid of an anomaly detection system (ADS) and traditional rules-based IDSs because it triggers on unexpected energy draining events using statistical bounds to assess an attack. DTC is less prone to false positive alerts because the DTC considers normal power draining activities and then only triggers an alert when the threshold is exceeded by the device's response to anomalous activity. When a threshold breach occurs, DTC transmits alerts which continue white the DTC value is exceeded. The value of the dynamic threshold calculation is stored in memory 59 for continuous analysis.

The node activity calculation 60 is a simple historical time stamped calculation of sensor node wake time versus sleep time as a percentage and is stored in memory 61 for further analysis. At this point, the data analysis has been completed at 62.

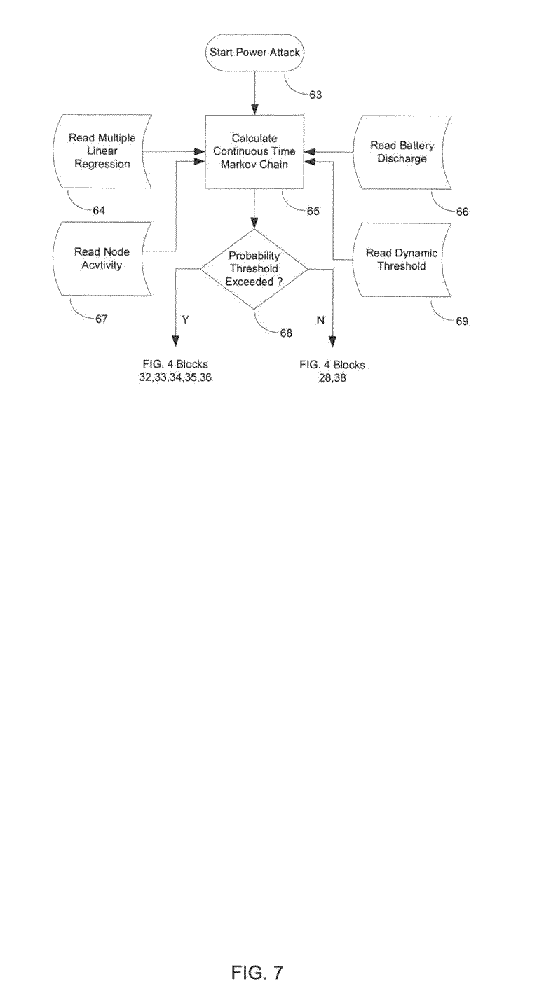

FIG. 7 details the algorithm starting at 63 to determine a power attack. Data is read from memory into a continuous-time Markov chain algorithm at 65. In probability theory, a continuous-time Markov chain (CTMC) is a mathematical model which takes values in some finite or countable set and for which the time spent in each state takes non-negative real values and has an exponential distribution. It is a continuous-time stochastic process with the Markov property which means that future behavior of the model (both remaining time in current state and next state) depends only on the current state of the model and not on historical behavior. The model is a continuous-time version of the Markov chain model, named because the output from such a process is a sequence (or chain) of states. The data read into the algorithm may include: 1) data from the multiple linear regression analysis 64, 2) data from the battery discharge analysis 66, 3) data from the node activity analysis 67, and 4) data from the dynamic threshold analysis 69. The output of the CTMC algorithm 65 calculates the probability of a power attack, if the probability threshold at 68 is exceeded, one or more of blocks 32, 33, 34, 35 and 36 (FIG. 4) are executed, otherwise notifications are cleared and normal sensor node operation is resumed at block 38 (FIG. 4). If a previous attack was not detected, power attack monitoring continues in FIG. 4.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for detecting and preventing battery exhaustion attacks, comprising:
collecting data from a battery powered mobile device;
analyzing the collected data;
determining if a power attack has occurred by analyzing the data using a continuous-time Markov chain algorithm; and
preventing the power attack if the power attack occurred.
